(19) United States
(12) Patent Application Publication
(10) Pub. No.: US 2005/0259112 A1
(43) Pub. Date: Nov. 24, 2005

(54) Information processing apparatus and display control method for information processing apparatus

(76) Inventors: Hajime Suzukawa, Hino-shi (JP); Atsushi Kaneko, Akiruno-shi (JP); Makoto Kosaka, Kodaira-shi (JP); Masaya Endo, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/135,281

(22) Filed: May 24, 2005

(30) Foreign Application Priority Data
May 24, 2004 (JP) 2004-153715

(51) Int. Cl. G09G 5/02

(52) U.S. Cl. 345/603

(57) ABSTRACT

According to this invention, an information processing apparatus includes a display, a processor which executes a predetermined program process for data to be displayed on the display, and outputs first data as a result of execution, and an external input terminal which externally inputs second data to be displayed on the display. The information processing apparatus further includes a controller which switches between the first data output from the processor and the second data input to the external input terminal, and displays the first data or the second data, that is different from the data displayed on the display before switching, on the display.

### CROSS-REFERENCE TO RELATED APPLICATIONS

This application is based upon and claims the benefit of priority from prior Japanese Patent Application No. 2004-153715, filed May 24, 2004, the entire contents of which are incorporated herein by reference.

### BACKGROUND OF THE INVENTION

1. Field of the Invention

The present invention relates to an information processing apparatus having a display function and a display control method for the information processing apparatus.

2. Description of the Related Art

In recent years, as described in, e.g., Jpn. Pat. Appln. KOKAI Publication No. 2003-195844, personal computers with an AV information appreciation function have prevailed. This AV information appreciation function allows the user to appreciate program information such as externally provided television (TV) broadcasting, and various kinds of audio/visual (AV) information such as moving image information provided by an external video playback apparatus.

The personal computer of this type has a system configuration which drives and controls the AV information appreciation function under the management and control of the operating system (OS), and a system configuration which independently activates the AV function without activating the OS.

In the system configuration which drives and controls the AV information appreciation function under the OS control, the user must wait until activation of the OS is completed when intending to appreciate AV information. In the system configuration which independently activates the AV function without activating the OS, independent operation of the AV function makes the arrangement of the entire apparatus complex and economically disadvantageous. In these system configurations, the user cannot arbitrarily switch, by simple operation, between a display environment in which externally input video information is appreciated and a processing work environment accompanied by data display including a CPU process.

### BRIEF SUMMARY OF THE INVENTION

According to an embodiment of the present invention, an information processing apparatus comprises a display, processor, external input terminal, and controller. The processor executes a predetermined program process for data to be displayed on the display, and outputs first data as a result of execution. The external input terminal externally inputs second data to be displayed on the display. The controller switches between the first data to be displayed on the display, output from the processor, and the second data to be displayed on the display, input to the external input terminal.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an example of the external appearance of an information processing apparatus according to an embodiment of the present invention;

FIG. 2 is a block diagram showing an example of the internal arrangement of the information processing apparatus according to the embodiment;

FIG. 3 is a flowchart showing an example of the procedures of a process according to the embodiment;

FIG. 4 is a flowchart showing an example of the procedures of a display select process according to the embodiment; and

FIG. 5 is a schematic view showing display select operation according to the embodiment.

### DETAILED DESCRIPTION OF THE INVENTION

An embodiment of the present invention will be described hereinafter with reference to several views of the accompanying drawing.

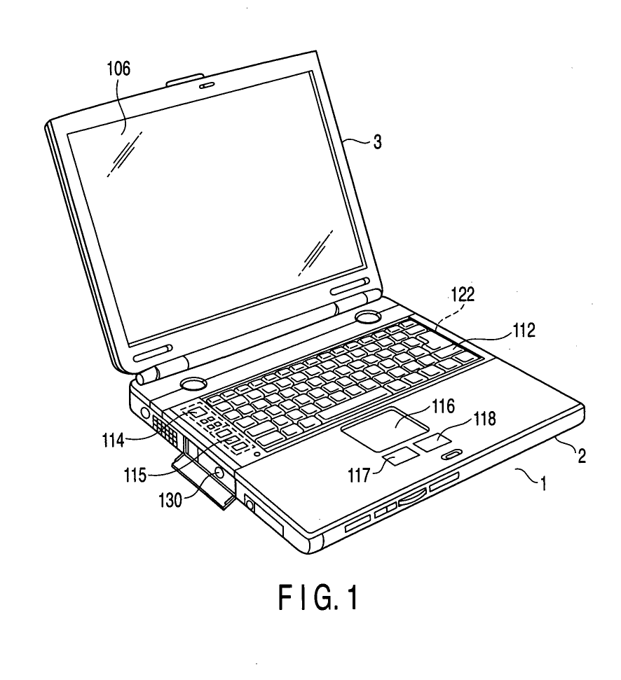

An information processing apparatus according to the embodiment of the present invention will be explained with reference to FIG. 1. The information processing apparatus is implemented as, e.g., a notebook type personal computer.

FIG. 1 is a front view showing an example of a state in which a display unit 3 of an information processing apparatus 1 is open with respect to an apparatus main body 2. The information processing apparatus 1 comprises the apparatus main body 2 and display unit 3. A display 106 using an LCD (Liquid Crystal Display) is built in nearly the center of the display unit 3 so that its display surface is exposed. The display unit 3 is attached to the apparatus main body 2 to be pivotal between the open and close positions.

The apparatus main body 2 has a box shape, and the side surface of the apparatus main body 2 is provided with, e.g., the medium insertion/removal port of a DVD drive 122 incorporated in the apparatus main body 2, and a video input terminal (composite signal input terminal) 130 which can input an external video signal. The side surface of the apparatus main body 2 is further provided with a USB connector, video output connector, IEEE1394 connector, PC card slot, SD card slot, and the like though the reference symbols of these components are not shown.

The upper surface of the apparatus main body 2 is provided with a keyboard unit 112, a power button 114 used to turn on/off the power supply of the information processing apparatus 1, a display select button 115 used to switch display data to be displayed on the display 106 (switch the path and display mode), and the like.

The display select button 115 is operated every time display of data internally processed within the apparatus and display of data (video data generated from a composite signal) externally input to the video input terminal 130 are switched and displayed on the display 106.

The upper surface of the apparatus main body 2 is also provided with a loudspeaker (not shown), a touchpad 116 having the scroll function of a mouse, a left button 117 serving as the left click function of a mouse, a right button 118 serving as the right click function of a mouse, and the like.

The front surface of the apparatus main body 2 is provided with an AV playback switch which designates playback of AV contents stored in a medium (disk) set in the DVD drive 122 incorporated in the apparatus main body 2, a volume dial, and the like though the reference symbols of these components are not shown.

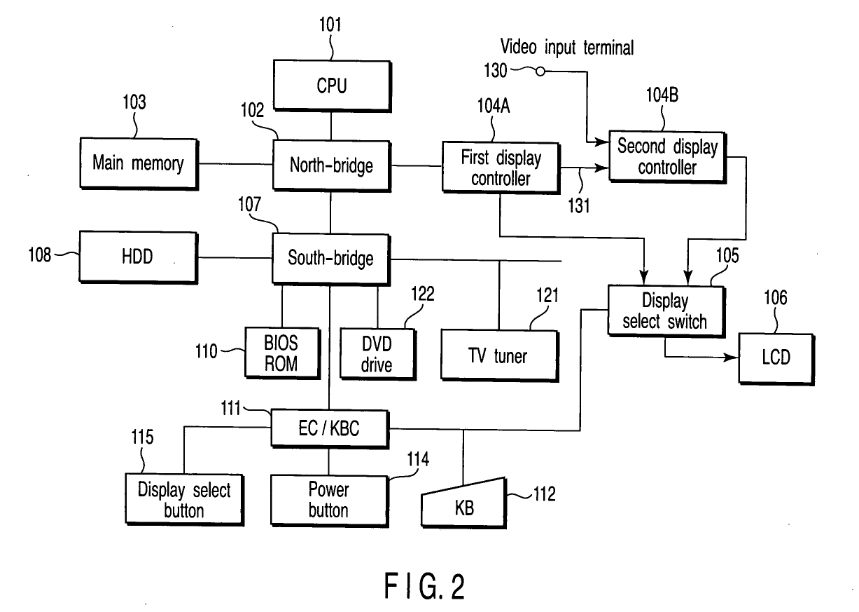

An example of the system configuration of the information processing apparatus 1 according to the embodiment of the present invention will be described below with reference to FIG. 2.

The information processing apparatus 1 comprises various building components such as a CPU 101, a north-bridge 102 and south-bridge 107, a main memory 103, a first display controller 104A, a second display controller 104B, a display select switch 105, the display (LCD) 106, a hard disk drive (HDD) 108, a BIOS-ROM 110, an embedded controller/keyboard controller (EC/KBC) 111, the keyboard unit (KB) 112, the power button 114, the display select button 115, a television (TV) tuner 121, the DVD drive 122, and the video input terminal (composite signal input terminal) 130.

The CPU 101 is a processor adopted to control the operation of the information processing apparatus according to the embodiment. The CPU 101 executes an operating system (OS) and various applications/utility programs loaded from the hard disk drive 108 serving as an external storage device onto the main memory 103 via the south-bridge 107 and north-bridge 102. The CPU 101 also executes a BIOS (Basic Input Output System) stored in the BIOS-ROM 110.

The north-bridge 102 is a bridge device which connects the CPU 101 to the south-bridge 107. The north-bridge 102 incorporates a memory controller (not shown) which controls access to the main memory 103. The north-bridge 102 is connected to the first display controller 104A.

The main memory 103 stores the operating system (OS), various application programs, utility programs, a display driver acting as an interface between these applications and the BIOS, and the like, which are to be executed by the CPU 101.

The main memory 103 stores various programs: for example, for display of data (video data generated from a composite signal) externally input to the video input terminal 130, a utility program which sets automatic/manual select of the display and functions part of the user interface of the information processing apparatus according to the embodiment, and for display (e.g., display in the full-screen mode of DVD images) under predetermined setting conditions, a control program which implements settings, a control function accompanying the settings, and the like when a display image processed by the first display controller 104A undergoes processes in display (e.g., image processes for higher quality such as ghost reducer, noise reduction, 10-bit A/D conversion, 3D Y/C separation, time-base corrector, digital sharpness, digital overdrive, deblocking, interlace/progressive conversion, color correction, deringing, black enhancer, white enhancer, edge enhancer, and dynamic contrast adjustment) set in advance by the second display controller 104B and output to the display 106.

The first display controller 104A controls display and output of data (internally processed data) which is internally processed by the CPU 101 and is to be displayed on the display 106. The first display controller 104A is connected to the second display controller 104B via a dedicated signal line 131.

The second display controller 104B has a processing function for performing processes (image processes for higher quality) such as ghost reducer, noise reduction, 10-bit A/D conversion, 3D Y/C separation, time-base corrector, digital sharpness, digital overdrive, deblocking, interlace/progressive conversion, color correction, deringing, black enhancer, white enhancer, edge enhancer, and dynamic contrast adjustment described above for display data received from the first display controller 104A via the dedicated signal line 131 and outputting the processed data, and a processing function for converting an external video signal (composite signal) input to the video input terminal 130 into display data for LCD display and outputting the converted data.

The second display controller 104B also has a processing function for, when a video signal (composite signal) is externally input to the video input terminal 130, detecting the signal input, converting the input video signal (composite signal) into display data for LCD display, and outputting the converted data.

The second display controller 104B further has a function for notifying the embedded controller/keyboard controller 111 via the BIOS of the detected state of the signal input.

In addition, the second display controller 104B has a function for, when input of an external video signal (composite signal) is detected while display data (internally processed data) received from the first display controller 104A undergoes a predetermined process (image process for higher quality) and is output, converting the video signal (composite signal) input to the video input terminal 130 into display data for LCD display and outputting the converted data preferentially to the internally processed data.

Valid/invalid setting of this function is performed by the utility program which sets automatic/manual select for display of externally input data, as described above.

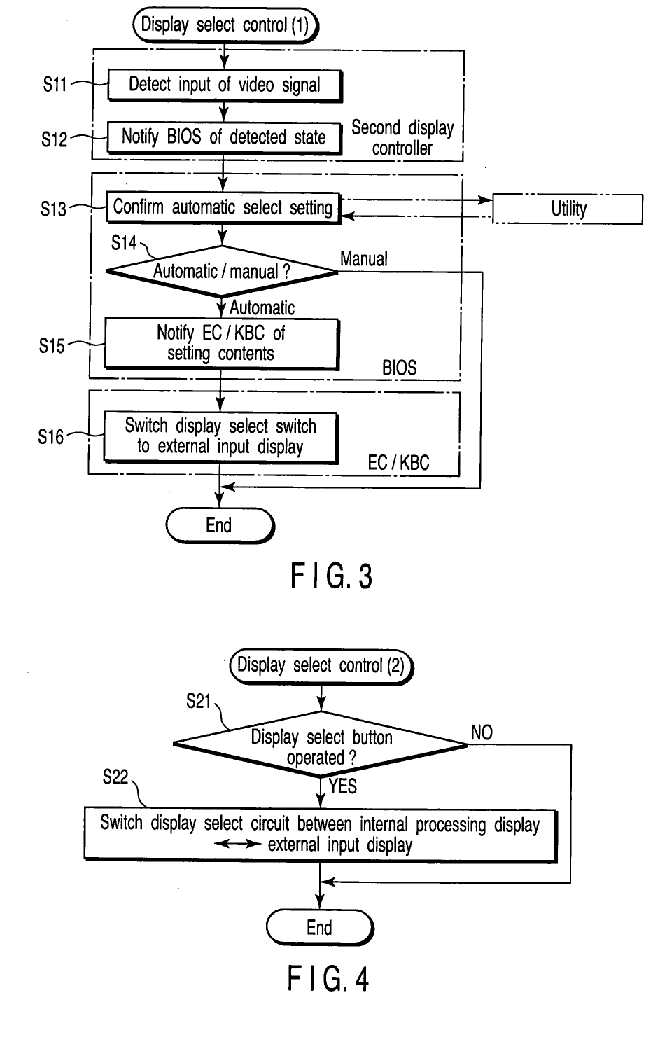

When automatic select is set by setting of automatic/manual select, the display select switch 105 is switched by a display select control signal generated by the embedded controller/keyboard controller 111 upon detection of the externally input signal. The display select process will be described with reference to the flowcharts shown in FIGS. 3 and 4.

Display data (internally processed data) for LCD display that is output from the first display controller 104A and display data (externally input data or internally processed data having undergone a process) for LCD display that is output from the second display controller 104B are input to the display select switch 105.

The display select switch 105 selects, as a select target, either of display data (internally processed data) for LCD display that is output from the first display controller 104A and display data (externally input data or internally processed data having undergone a process) for LCD display that is output from the second display controller 104B in accordance with a display select control signal generated by the embedded controller/keyboard controller 111, and supplies the selected display data to the display 106.

The display select control signal generated by the EC/KBC 111 will be described later. The display 106 displays the display data supplied from the display select switch 105.

The south-bridge 107 is a bridge device connected to the north-bridge 102. The south-bridge 107 is connected to the hard disk drive (HDD) 108, BIOS-ROM 110, embedded controller/keyboard controller 111, television (TV) tuner 121, DVD drive 122, and the like.

The hard disk drive (HDD) 108 stores the OS, device drivers, application programs to be executed, data generated upon execution of the application programs, and the like. Pieces of data stored in the hard disk drive (HDD) 108 are transferred to the main memory 103 as needed for a program process of the CPU 101, and undergo the processing of the CPU 101.

The BIOS-ROM 110 stores a BIOS executed by the CPU 101. The display control routine of the BIOS includes a processing step of acquiring (loading) setting data on automatic/manual select of externally input display (external monitor display) that is set by the above-described utility program and sets whether to switch the display manually or automatically for data (composite signal) externally input to the video input terminal 130, and a processing step of notifying the embedded controller/keyboard controller 111 of the acquired setting contents of automatic/manual select (see steps S13 and S14 shown in FIG. 3).

The embedded controller/keyboard controller 111 is a 1-chip microcomputer which integrates an embedded controller that controls peripheral function circuits including power management, and a keyboard controller that controls the keyboard unit 112.

The embedded controller/keyboard controller 111 is connected to the display select switch 105 and display select button 115 serving as building components which implement the display select control according to the present invention, in addition to building components such as the keyboard unit 112 and a power button 114.

The embedded controller/keyboard controller 111 switches and controls the display select switch 105 on the basis of setting data of automatic/manual select notified from the BIOS, and the operation signal of the display select button 115.

For example, the display select switch 105 selects display data (internally processed data) for LCD display that is output from the first display controller 104A, and the internally processed data is displayed on the display 106. At this time, if a detection signal representing that a video signal (composite signal) has been input to the video input terminal 130 is received from the second display controller 104B, whether the setting contents of automatic/manual select notified from the BIOS represent automatic select or manual select is checked.

For automatic select, the display select button 115 is switched and controlled by the display select control signal to output from the display 106 display data (externally input data) for LCD display that is output from the second display controller 104B, instead of display data (internally processed data) for LCD display that is output from the first display controller 104A (see step S16 in FIG. 3).

When the setting contents represent manual select, the display is not switched at the signal detection timing, and the display select switch 105 is switched and controlled in accordance with the operation signal of the display select button 115 every time the button is operated.

Display data (internally processed data) for LCD display that is output from the first display controller 104A and display data (externally input data or internally processed data having undergone a process) for LCD display that is output from the second display controller 104B are switched and displayed on the display 106 (see steps S21 and S22 in FIG. 4).

Input select of the display select switch 105 implements a function for selecting one of a path which outputs display data processed by the first display controller 104A to the display 106 without the mediacy of the second display controller 104B, a path which processes by the second display controller 104B display data processed by the first display controller 104A and outputs the processed data to the display 106, and a path which converts a video signal (composite signal) input to the video input terminal 130 into display data for LCD display by the second display controller 104B and outputs the display data to the display 106. The display select process at this time will be described later with reference to the flowcharts shown in FIGS. 3 and 4.

The embedded controller/keyboard controller 111 powers on/off the information processing apparatus 1 in accordance with an operation of the power button 114 by the user. The power button 114 is adopted to control power supply to devices such as the CPU 101 and main memory 103 which constitute the information processing apparatus 1, and then activate the OS.

When the user presses the power button 114, these devices are powered on, and then the CPU 101 executes the system activation process routine of a BIOS installed in the BIOS-ROM 110, thereby activating the OS. When the CPU 101 executes an initialization process routine, the result of, e.g., POST (Power On Self Test) in the initialization process routine is displayed on the display 106.

The TV tuner 121 is connected to the south-bridge 107 via, e.g., a USB interface. The TV tuner 121 receives TV broadcasting program data (contents) of a channel requested for viewing by a personal computer or the like via a remote controller or LAN (not shown). The TV broadcasting program data is converted into compressed/coded TV broadcasting program data via an internal NTSC decoder and MPEG encoder.

When the user is to view TV broadcasting program data, compressed/coded TV program data is decoded by an internal MPEG decoder, and the decoded TV program data is displayed on the display 106. When TV broadcasting program data is to be video-recorded, TV broadcasting program data compressed and coded by the MPEG encoder is stored in the hard disk drive (HDD) 108.

The DVD drive 122 connected to the south-bridge 107 performs, e.g., playback of contents recorded on a set (loaded) DVD disk.

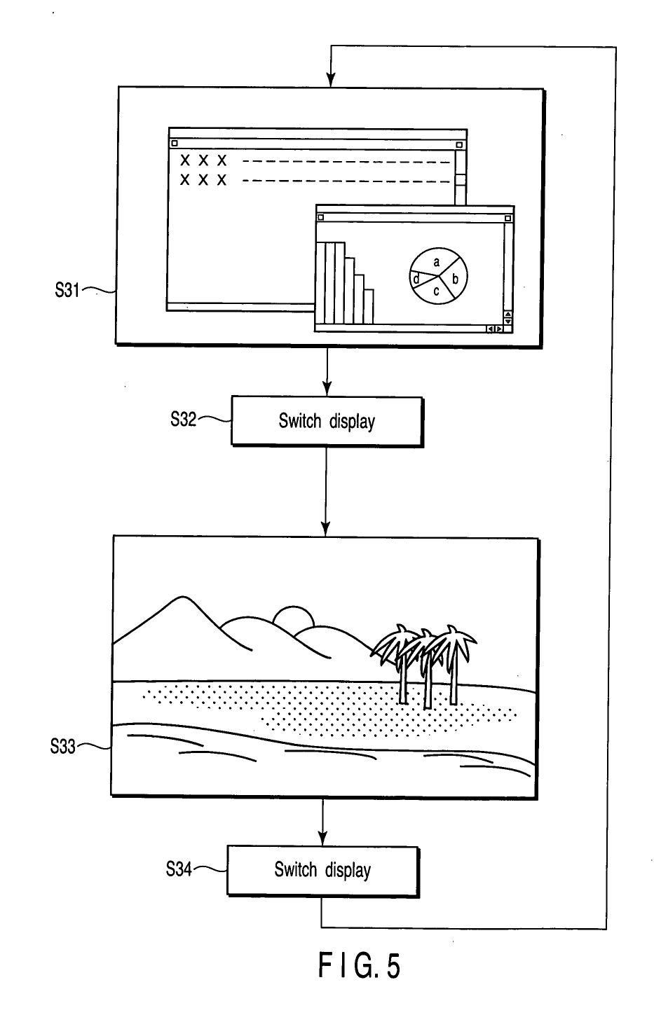

FIGS. 3 and 4 show the procedures of the display select process according to the embodiment of the present invention. FIG. 5 shows an example of state transition for explaining display select operation according to the embodiment.

The display select process according to the embodiment of the present invention will be explained with reference to FIGS. 3 to 5. As an initial display select state, display data (internally processed data) for LCD display that is output from the first display controller 104A is sent to the display 106 via the display select switch 105 and displayed on the display 106, as shown in, e.g., step S31 of FIG. 5.

In this state, if a video signal (composite signal) is externally input to the video input terminal 130, the second display controller 104B detects that the video signal (composite signal) has been input to the video input terminal 130 (step S11 in FIG. 3), and notifies the BIOS of the detected state (step S12 in FIG. 3).

Upon reception of the notification, the BIOS acquires, from the utility, setting data of automatic/manual select for external input display (external monitor display) that sets whether to perform display select manually or automatically for the data (composite signal) externally input to the video input terminal 130 (step S13 in FIG. 3), recognizes the contents (step S14 in FIG. 3), notifies the embedded controller/keyboard controller 111 of the recognized setting contents (step S15 in FIG. 3).

Upon reception of the setting contents from the BIOS, if the contents represent “automatic select”, the embedded controller/keyboard controller 111 switches and controls the display select button 115 by a display select control signal, and outputs to the display 106 display data (externally input data) for LCD display that is output from the second display controller 104B, instead of display data (internally processed data) for LCD display that is output from the first display controller 104A (step S16 in FIG. 3).

More specifically, when “automatic select” is set by the utility, data displayed on the display 106 is switched in response to input of a video signal (composite signal) to the video input terminal 130 from data internally processed by the CPU 101 as shown in step S31 of FIG. 5 via the display select step of step S32 to externally display data (e.g., moving image) converted for LCD display from the video signal (composite signal) processed by the second display controller 104B as shown in step S33.

When the setting contents represent “manual select”, display select at a timing in response to signal detection is not performed. Every time the display select button 115 is operated, the embedded controller/keyboard controller 111 switches and controls the display select switch 105, switches between display data (internally processed data) for LCD display that is output from the first display controller 104A as shown in step S31 of FIG. 5 and display data (externally input data or internally processed data having undergone a process) that is output from the second display controller 104B, and displays the data on the display 106 (steps S21 and S22 in FIG. 4).

As described above, a display select processing function which includes the display select button 115 and switches between externally input data and internally processed data is implemented. A display environment in which externally input video data is appreciated and a processing work environment accompanied by data display including a process of the CPU 101 can be provided with simple user operation.

Note that the present invention is not limited to the above embodiments, and can be variously modified and implemented without departing from the spirit and scope of the invention when put into practice. Various inventions can be achieved by an appropriate combination of building components disclosed in the embodiment. For example, several building components may be omitted from all the building components described in the embodiment. Further, building components in different embodiments may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus comprising:
a display;
a processor which executes a predetermined program process for data to be displayed on the display, and outputs first data as a result of execution;
an external input terminal which externally inputs second data to be displayed on the display; and
a controller which switches between the first data to be displayed on the display, output from the processor, and the second data to be displayed on the display, input to the external input terminal.

2. The information processing apparatus according to claim 1, wherein when the second data is input to the external input terminal, the controller detects the input, switches between the first data to be displayed on the display, output from the processor, and the second data to be displayed on the display, input to the external input terminal.

3. The information processing apparatus according to claim 1, further comprising:
a body which incorporates the processor and has the external input terminal,
an operation switch which is provided on the body, and switches between the first data processed by the processor and the second data input to the external input terminal, and
a display housing which is pivotally provided on the body and has the display.

4. The information processing apparatus according to claim 2 or 3, wherein when a video signal is input as the second data to the external input terminal, the controller detects input of the video signal, and displays, on the display, display data obtained by processing the video signal input to the external input terminal, instead of the first data output from the processor.

5. The information processing apparatus according to claim 4, wherein the controller comprises
a first display controller and a second display controller which control the display,
a first path which outputs display data processed by the first display controller to the display after a process by the second display controller,
a second path which outputs the display data processed by the first display controller to the display without going through the second display controller,
a third path which outputs the second data input to the external input terminal to the display after a process by the second display controller, and
a display selector which selects one of the first to third paths.

6. The information processing apparatus according to claim 5, wherein
the processor comprises at least a video playback device or a television tuner via an internal bus, and
when the processor processes and outputs data played back by the video playback device or a video signal received by the television tuner, the display selector selects the first path.

7. The information processing apparatus according to claim 6, wherein when the video signal is input to the external input terminal, the display selector selects the third path.

8. The information processing apparatus according to claim 2 or 3, wherein the controller comprises
a first display controller and a second display controller which control the display,
a first path which outputs display data processed by the first display controller to the display after a process by the second display controller,
a second path which outputs the display data processed by the first display controller to the display without going through the second display controller,
a third path which outputs the second data input to the external input terminal to the display after a process by the second display controller, and
a display selector which selects one of the first to third paths.

9. The information processing apparatus according to claim 8, wherein
the processor comprises at least a video playback device or a television tuner via an internal bus, and
when the processor processes and outputs data played back by the video playback device or a video signal received by the television tuner, the display selector selects the first path.

10. The information processing apparatus according to claim 9, wherein when the video signal is input to the external input terminal, the display selector selects the third path.

11. The information processing apparatus according to claim 8, wherein when the video signal is input to the external input terminal, the display selector selects the third path.

12. The information processing apparatus according to claim 5, wherein when the video signal is input to the external input terminal, the display selector selects the third path.

13. The information processing apparatus according to claim 3, wherein the controller includes a mode select device which switches between a manual select mode in which switching is performed using the operation switch, and an automatic select mode in which when a video signal is input to the external input terminal, input of the video signal is detected and display data obtained by processing the video signal input to the external input terminal is displayed on the display instead of the first data output from the processor.

14. A display control method of controlling data displayed on an information processing apparatus, the information processing apparatus comprising
a display,
a processor which executes a predetermined program process for data to be displayed on the display, and outputs first data as a result of execution,
an external input terminal which externally inputs second data to be displayed on the display, and a select switch which switches data output from the display,
the method comprising switching data displayed on the display from the first data to the second data or from the second data to the first data every time the select switch is operated.

15. The method according to claim 14, wherein when the first data is displayed on the display and a video signal is input as the second data to the external input terminal, display data obtained by processing the video data is displayed on the display instead of the first data.

16. The method according to claim 14 or 15, wherein
the information processing apparatus comprises
a first display controller and a second display controller which control the display,
a first path which outputs display data processed by the first display controller to the display after a process by the second display controller,
a second path which outputs the display data processed by the first display controller to the display without going through the second display controller, and
a third path which outputs the second data input to the external input terminal to the display after a process by the second display controller, and
the method further comprises switching the first data to be displayed on the display and the second data to be displayed on the display by switching between the third path and one of the first path and the second path every time the select switch is operated.
